(19) United States
(12) Patent Application Publication
(10) Pub. No.: US 2019/0210033 A1
(43) Pub. Date: Jul. 11, 2019

(54) VERTICAL SHAFT IMPACTOR WITH EXTERNALLY ADJUSTABLE ANVIL RING

(71) Applicant: Stedman Machine Company, Aurora, IN (US)

(72) Inventors: Jacob Woeste, Cincinnati, OH (US); Tyler Cianciolo, Fort Mitchell, KY (US); Paul Dietrich, Harrison, OH (US); Jason Potter, Rising Sun, IN (US)

(21) Appl. No.: 15/863,231

(22) Filed: Jan. 5, 2018

(51) Int. Cl. B02C 13/282; B02C 13/14

(52) U.S. Cl. CPC B02C 13/282; B02C 2013/2825; B02C 13/14

(57) ABSTRACT

An anvil adjustment assembly of a vertical shaft impactor includes an anvil ring configured to be disposed within a housing of the vertical shaft impactor. The anvil ring includes a tab which is coupled to an elongate jack bolt having a first end and a second end. A jack bolt housing partially surrounds the bolt and is coupled to the housing. A first locking collar and a second locking collar are coupled to the jack bolt. The first locking nut is coupled to the jack bolt on one side of the tab, and the second locking nut is coupled to the jack bolt on the opposite side of the tab. The jack bolt moves along a longitudinal axis within the jack bolt housing between a first position and a second position, and the movement of the jack bolt along the longitudinal axis induces longitudinal movement of the anvil ring.

### TECHNICAL FIELD

The present teachings are related to crushing larger materials into smaller pieces, and in particular, to the apparatus, components, and methods for crushing within a controlled environment.

### BACKGROUND

Impact crushing apparatuses are known and employed in various industries for reducing materials such as rock, concrete, brick, stone, and other earthly materials into smaller shapes and sizes for further use or disposal of. In a typical impact crushing apparatus, materials are fed into a chamber and onto a rotating feed disk. The material is thrown from the center of the rotating feed disk at high speeds against an impact surface, where due to the centrifugal forces, the material is broken into smaller pieces.

Over time and after repeated use, the impact surface of the impact crusher can become worn and require maintenance or replacement. Adjustment of the impact surface can prolong its life and reduce the number of times that maintenance or replacement is needed. Current adjustment techniques require internal access, manual removal, and precise replacement into the adjusted position. Adjustment can prove difficult because material buildup between the housing and the impact surface can cause it to become jammed. Large machinery including cranes may be necessary to release the jam. Because of this, the adjustment process can take time, require considerable effort, and be dangerous to personnel.

Based on these considerations, there is a need to improve the apparatus, components, and method for adjusting the impact surface. More specifically, there is a need for an impact crusher apparatus with quicker, safer, and easier impact surface adjustment.

### SUMMARY

In a first embodiment of this disclosure, an anvil adjustment assembly of a vertical shaft impactor includes an anvil ring configured to be disposed within a housing of the vertical shaft impactor, the anvil ring comprising at least one tab protruding outwardly; an elongate jack bolt having a first end and a second end, the bolt including a threaded portion formed between the first and second ends; a jack bolt housing having a cover and a door, the jack bolt housing configured to be coupled to the housing; a first locking collar and a second locking collar each coupled to the jack bolt, where the first locking nut is coupled to the jack bolt on one side of the at least one tab, and the second locking nut being coupled to the jack bolt on the opposite side of the at least one tab; wherein, the jack bolt is movable along a longitudinal axis within the jack bolt housing between a first position and a second position; further wherein, a movement of the jack bolt along the longitudinal axis induces longitudinal movement of the anvil ring.

In one example of this embodiment, a first locking nut is coupled to the first end of the jack bolt and a second locking nut is fixedly coupled to the jack bolt housing, wherein rotational movement of the first locking nut induces longitudinal movement of the jack bolt relative to the second locking nut. In a second example, the first and second locking collars are coupled to the jack bolt and move longitudinally with the jack bolt. In a third example, the jack bolt moves longitudinally between an upper limit and a lower limit, where at the upper limit the at least one tab contacts the jack bolt housing and at the lower limit the at least one tab is configured to contact the housing.

In a fourth example, the jack bolt housing includes a top, a bottom, a first side, a second side, a first wall, and a second wall, wherein the second side includes at least three edges that define an opening through which the at least one tab is received in the jack bolt housing. In a fifth example, the at least one tab includes a plurality of tabs circumferentially and equidistantly spaced from one another. In another example, the at least one tab defines an opening through which the jack bolt is inserted. In a further example, the anvil ring includes an inner surface that defines a plurality of slots, where each of the plurality of slots is configured to receive an anvil.

In another embodiment of this disclosure, a vertical shaft impactor includes a housing including an outer wall that defines an interior chamber, the outer wall further defining a cutout portion; a lid coupled to the housing for closing off the interior chamber; an anvil ring disposed within the interior chamber; a bolt assembly coupled to the housing, the bolt assembly comprising a bolt housing and a bolt that moves in a longitudinal direction within the bolt housing; wherein, the bolt housing comprises at least one side having an open face for receiving the anvil ring; wherein, the bolt is coupled to the anvil ring such that longitudinal movement of the bolt induces longitudinal movement of the anvil ring.

In a first example of this embodiment, the bolt assembly is coupled to the outer wall at the cutout. In a second example, the anvil ring protrudes through the cutout and through an opening defined in the bolt housing. In a third example, an indicator plate is coupled to the housing at a location below the bolt assembly, the indicator plate including a plurality of markings indicative of length dimensions. In a fourth example, at least one tab of the anvil ring protrudes outwardly and is configured to be coupled to the bolt.

In another example, a first locking collar and a second locking collar are each coupled to the bolt, where the first locking nut is coupled to the bolt on one side of the at least one tab, and the second locking nut is coupled to the bolt on the opposite side of the at least one tab. In yet another example, the first and second locking collars move longitudinally with the bolt. In yet another example, the bolt moves longitudinally between an upper limit and a lower limit, where in the upper limit the at least one tab contacts the bolt housing and in the lower limit the at least one tab is configured to contact the housing.

In a further embodiment of this disclosure, a vertical shaft impact crushing apparatus includes a housing; a chamber defined within the housing, the chamber having a central region and an outer periphery; a lid for closing the chamber, wherein the lid defines a plurality of openings positioned about the perimeter of the lid; an anvil ring configured to be disposed within a housing of the vertical shaft impactor, the anvil ring comprising at least one tab extending radially outwardly; an elongate jack bolt having a first end and a second end, the bolt including a threaded portion formed between the first and second ends; a jack bolt housing having a cover and a door, the jack bolt housing configured to be coupled to the housing; and a first locking collar and a second locking collar each coupled to the jack bolt, where the first locking nut is coupled to the jack bolt on one side of the at least one tab, and the second locking nut being coupled to the jack bolt on the opposite side of the at least one tab; wherein, the jack bolt is movable along a longitudinal axis within the jack bolt housing between a first position and a second position; further wherein, a movement of the jack bolt along the longitudinal axis induces longitudinal movement of the anvil ring.

In one example of this embodiment, a first locking nut is coupled to the first end of the jack bolt and a second locking nut is fixedly coupled to the jack bolt housing, wherein rotational movement of the first locking nut induces longitudinal movement of the jack bolt relative to the second locking nut and the jack bolt housing. In a second example, the first and second locking collars are coupled to the jack bolt such that both collars move longitudinally with the jack bolt but do not move relative to one another. In a third example, the jack bolt moves longitudinally between an upper limit and a lower limit, where at the upper limit the at least one tab contacts the jack bolt housing and at the lower limit the at least one tab is configured to contact the housing. In another example, the housing includes an outer wall with a defined cutout; the jack bolt housing is coupled to the housing at the location of the defined cutout, the jack bolt housing including a top, a bottom, a first side, a second side, a first wall, and a second wall; and the second side includes at least three edges that define an opening such that the at least one tab extends through the defined cutout and opening and is received in the jack bolt housing.

### DESCRIPTION OF THE DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 is an exploded, perspective view of a vertical shaft impactor with a plurality of adjustable jack bolt assemblies;

FIG. 2 is a perspective view of a jack bolt and jack bolt housing of the present disclosure;

FIG. 3 is a perspective view of a housing for the vertical shaft impactor of the present disclosure;

FIG. 4 is a perspective view of an exemplary anvil ring of the present disclosure;

FIG. 5 is a cross-sectional, perspective view of an adjustable jack bolt assembly of a vertical shaft impactor configured in an upper limit position; and

FIG. 6 is a cross-sectional view of the adjustable jack bolt assembly configured in a lower limit position.

Corresponding reference numerals are used to indicate corresponding parts throughout the several views.

### DETAILED DESCRIPTION

The above-mentioned aspects of the present disclosure and the manner of obtaining them will become more apparent and the teachings of the present disclosure itself will be better understood by reference to the following description of the embodiments of the present disclosure taken in conjunction with the accompanying drawings.

During operation of a vertical shaft impactor assembly, material such as rock, brick, stone, and the like is inserted into a rotating impellor which rotates at a high speed. The impellor may “throw” the material from a central portion of the assembly outwardly towards one or more anvils. The anvils are often secured to the housing and arranged such that an impact surface of each anvil is oriented in a direction facing the impellor. As such, the material is thrown by the impellor towards the anvils and contacts the anvils at a high speed to break apart or crush the material into smaller pieces. The smaller pieces may be further broken into even smaller pieces until the smaller pieces are transported out of the assembly.

The anvils are subject to damage as a result of the contact between their impact surface and the material. Thus, the anvils are routinely inspected and maintained. The conventional vertical shaft impactor may have an upper lid through which maintenance personnel accesses the interior of the impactor to repair, replace, or maintain the anvils and other components of the impactor. This can often require rotating the lid and lifting the existing anvil or anvils. In some cases, the anvils are held by an anvil ring, and the personnel must lift the entire anvil ring. These rings can be heavy and require the personnel to exert great energy and stress to perform maintenance.

Due to damage or wear to the anvils, the plurality of anvils may need regular adjustment for continued operation. This can be difficult to do on a conventional impactor due to limited space, small clearances, and dangerous surrounding environments. In other words, it is often difficult to adjust the plurality of anvils and/or anvil ring without accessing the interior of the impactor. In the present disclosure, a newly designed impactor is provided for adjusting the anvils in such a way that there is no need for accessing the interior of the impactor to accomplish the adjustments.

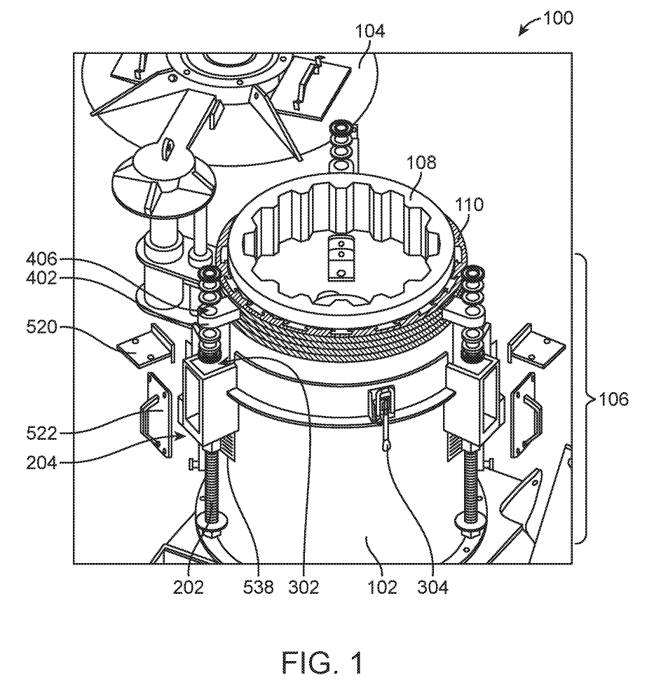

In FIG. 1, for example, one embodiment of a vertical shaft impactor (VSI) 100 of the present disclosure is illustrated. The VSI 100 includes a VSI housing 102, a VSI lid 104, at least one adjustable jack bolt assembly 106, a plurality of anvils 108, and an anvil ring 110. FIG. 1 demonstrates how the components of the present disclosure may be assembled and will be described in greater detail below. Additional reference to FIG. 1 will bring clarity to the components and functions of the present disclosure.

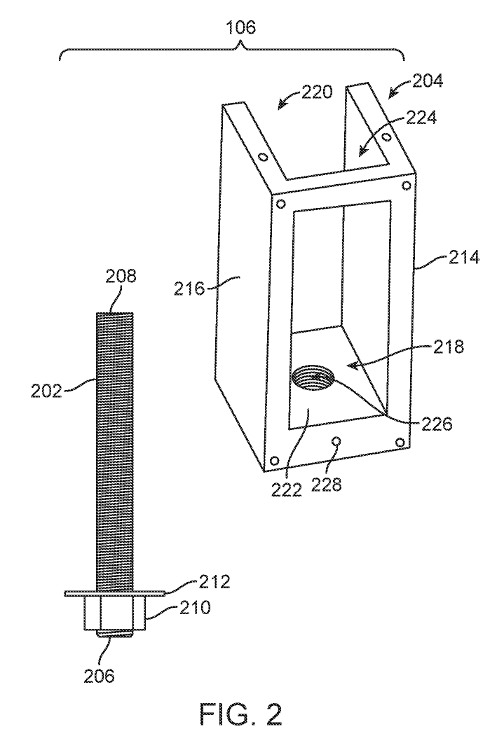

Referring to FIG. 2, the adjustable jack bolt assembly 106 may include a jack bolt 202. While this disclosure describes the use of a jack bolt 202, it is understood that other types of bolts may be used to accomplish the same as described herein. Moreover, elongated rods, poles, beams, or the like may also be used. In any event, the jack bolt 202 may be threaded and include a first end 206 and a second end 208. A first locking nut 210 may be coupled to the first end 206. The first locking nut 210 may be welded onto the jack bolt 202 so that the first locking nut 210 does not move relative to the bolt 202. A flat washer 212 may also be coupled to the jack bolt 202 adjacent to the first locking nut 210 as shown in FIG. 2. Additionally, the flat washer 212 may be coupled to the first locking nut 210.

The adjustable jack bolt assembly 106 may further include a jack bolt housing 204. The jack bolt housing includes a first wall 214, a second wall 216, a first side 218, a second side 220, a bottom 222, and a top 224 as shown in FIG. 2. The first side 218, the second side 220, and top 224 may be substantially open-faced. The first side 218 may be formed by four edges, whereas the second side 220 and the top 224 may be formed by three edges with their mutual edge missing as shown in FIG. 2. The bottom 222 may define a jack bolt opening 226 configured to receive the jack bolt 202 to the jack bolt housing 204. In a further embodiment, the opening 226 may threadably couple the jack bolt 202 to the jack bolt housing 204. The second end 208 of the jack bolt 202 may be inserted into the jack bolt hole 226 and screwed in until the jack bolt 202 is substantially disposed within the jack bolt housing 204. In one embodiment, the jack bolt housing 204 may further include a grease fitting 228 configured to house a lubricating substance that facilitates movement of the jack bolt 202.

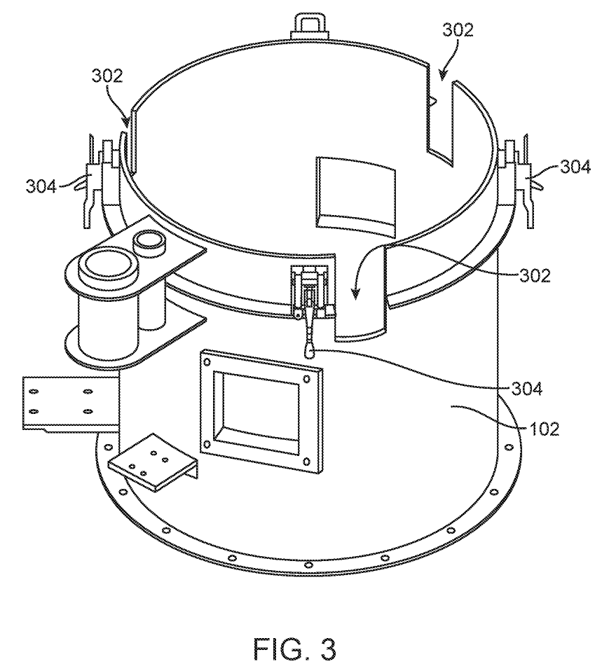

Referring to FIG. 3, an embodiment of the VSI housing 102 is illustrated. The VSI housing 102 includes a portion or cutout 302 removed therefrom to accommodate a jack bolt assembly 106. In FIGS. 1 and 3, the VSI housing 102 is shown having three jack bolt assembly cutouts or portions 302 spaced equidistant from each other, but any number of jack bolt assembly cutouts 302 in any spaced arrangement is contemplated. The second side 220 of the jack bolt housing 204 may be coupled to the VSI housing 102 at the jack bolt assembly cutout 302 via welding, clips, rivets, screws or any other coupling means known in the art.

The VSI housing 102 further includes a plurality of latches 304. The plurality of latches may be spaced circumferentially about the VSI housing 102 and configured to secure the lid 104 in place once the VSI 100 is ready for use. FIG. 3 illustrates the VSI housing 102 with three latches 304 coupled thereto and spaced equidistant from each other. In other embodiments, however, there may be any number of latches 304 disposed in any configuration.

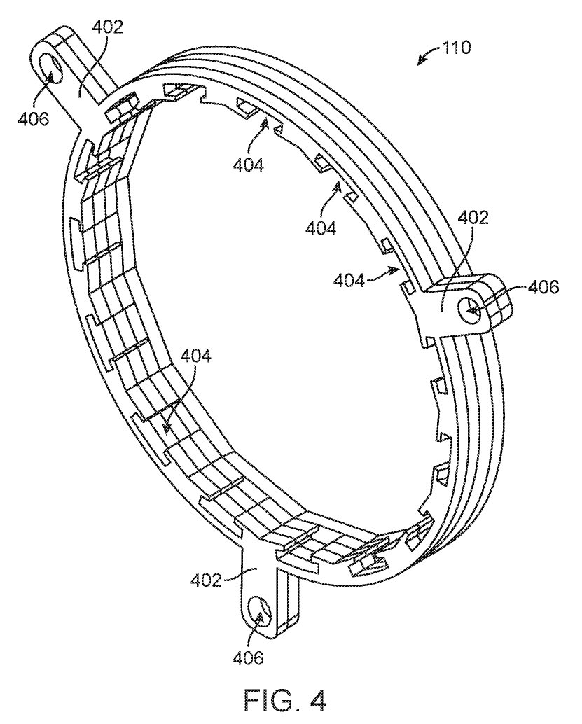

Referring now to FIG. 4, an exemplary anvil ring 110 is illustrated. The anvil ring 110 includes at least one tab 402. The illustrated embodiment of the anvil ring 110 in FIGS. 1 and 4 has three tabs 402 spaced equidistant from each other, but any number of tabs 402 in any configuration is contemplated. Each tab 402 provides a point of contact with the VSI housing 102. As illustrated in FIG. 1, when the VSI 100 is fully assembled, the anvil ring 110 is positioned within the VSI housing 102, and the tabs 402 of the anvil ring 110 may be positioned within the cutouts or removed portions 302 defined in the VSI housing 102 and opening formed in the second side 220 of the jack bolt housing 204. In other words, for each tab 402 of the anvil ring 110, there is a corresponding cutout 302 in the VSI housing 102 and jack bolt assembly 106 such that each tab 204 fits within a cutout 302 and opening formed in the second side 220 of the jack bolt housing 204.

The tab 402 of the anvil ring 110 may include a jack bolt hole 406. The jack bolt hole 406 is configured to couple the tab 402 of the anvil ring 110 to the jack bolt 202 of the jack bolt assembly 106. As illustrated in FIG. 1, upon assembly of the anvil ring 110 in the VSI housing 102, the one or more tabs 402 may be positioned within the jack bolt housing 204 through the openings defined in the top 224 and second side 220 of the jack bolt housing 204 to be coupled with the second end 208 of the jack bolt 202.

Referring still to FIG. 4, the anvil ring 110 may further define a plurality of anvil slots 404 along an interior surface thereof. The plurality of anvil slots 404 may provide a means for coupling the plurality of anvils 108 to the anvil ring 110. For instance, the plurality of anvils 108 may have protrusions that slide into the anvil slots 404 such that the anvil ring 110 may couple and stabilize the plurality of anvils 108 while the VSI 100 is in use. It is contemplated, however, that the plurality of anvils 108 may be designed with slots and the anvil ring 110 may be designed with protrusions such that the protrusions of the anvil ring 110 can slide into the slots of the plurality of anvils 108. Any other coupling mechanism now known or later developed may be used to couple the plurality of anvils 108 to the anvil ring 110.

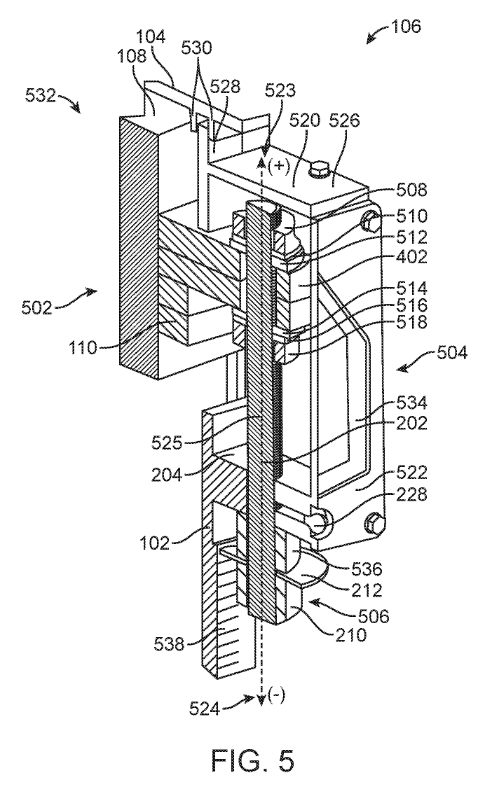

FIG. 5 illustrates one example of the adjustable jack bolt assembly 106 configured to adjust the position of the plurality of anvils 108 substantially within the VSI housing 102 without having to access the interior of the VSI housing 102. While FIG. 5 illustrates a single adjustable jack bolt assembly 106, the VSI 100 may have multiple jack bolt assemblies 106 for externally adjusting the plurality of anvils 108 within the VSI 100 as previously described. The adjustable jack bolt assembly 106 may be formed of an interior portion 502, a jack bolt housing portion 504, and an exterior portion 506. The interior portion 502 may be disposed substantially within the VSI housing 102. The jack bolt housing portion 504 may be disposed substantially outside the VSI housing 102, but substantially within the jack bolt housing 204. The exterior portion 506 may be adjacent to but substantially outside both the VSI housing 102 and the jack bolt housing 204.

The interior portion 502 of the adjustable jack bolt assembly 106 may include the plurality of anvils 108 and the anvil ring 110. The plurality of anvils 108 may be coupled to the anvil ring 110 in the manner described above such that the anvil ring 110 maintains the plurality of anvils 108 in a substantially stationary position while the VSI 100 is in use. In other words, the plurality of anvils 108 may remain within the slots 406 defined in the anvil ring 110, but each anvil may have limited movement within the corresponding slot as rock or other material contacts the anvil.

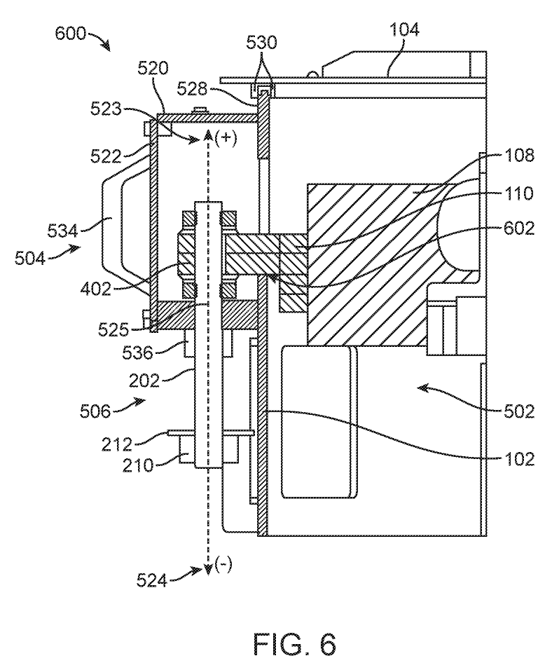

The jack bolt housing portion 504 of the adjustable jack bolt assembly 106 may include the anvil ring tab 402, the jack bolt 202, a first locking collar 508, a first non-metal washer 510, a first metal washer 512, a second metal washer 514, a second non-metal washer 516, a second locking collar 518, a cover 520, a door 522, and the jack bolt housing 204. The components of the jack bolt housing portion 504 can be seen in an assembled form in FIGS. 5 and 6 and in an unassembled form in FIG. 1. Further characteristics and functional descriptions of these components will be explained in more detail below.

As shown in FIG. 5 and briefly described above, the jack bolt 202 couples with the tab 402 of the anvil ring 110 through the jack bolt hole 406. A jack bolt axis 525, having a positive direction 523 and a negative direction 524, extends through the center of the jack bolt 202. The first locking collar 508 may couple with the second end 208 of the jack bolt 202 on one side of the tab 402, and the second locking collar 518 may couple with the jack bolt 202 on the other side of the tab 402 as shown in FIG. 5. The locking collars 508, 518 are coupled to the jack bolt 202 in such a way that the locking collars 508, 518 move along the jack bolt axis 525 with the jack bolt 202, but do not move relative to each other or the jack bolt 202. The locking collars 508, 518 are configured to secure the tab 402 in a certain position along the jack bolt 202 such that when the jack bolt 202 moves along the jack bolt axis 525, so does the tab 402.

The first metal washer 512 and the first non-metal washer 510 may be coupled to the jack bolt 202 between the first locking collar 508 and the tab 402. The first metal washer 512 may be disposed closer to the tab 402 and the first non-metal washer 510 may be disposed closer to the first locking collar 508 as illustrated in FIG. 5. Additionally, the second metal washer 514 and the second non-metal washer 516 may be coupled to the jack bolt 202 between the second locking collar 518 and the tab 402. The second metal washer 514 may be disposed closer to the tab 402 and the second non-metal washer 516 may be disposed closer to the second locking collar 518 as illustrated in FIG. 5. The washers 510, 512, 514, 516 may be configured to keep the first and second locking collars 508, 518 from slipping while securing the tab 402. The washers 510, 512, 514, 516 may be arranged differently, or there may be additional or fewer washers in alternate embodiments.

Referring to FIG. 5 still, the cover 520 may include a coupling piece 526 configured to removably couple the cover to the top 224 of the jack bolt housing 204 via screws, bolts, rivets, clamps or any other coupling mechanism known in the art. The cover 520 may be removed from the jack bolt housing 204 to allow for maintenance or replacement of the components of the adjustable jack bolt assembly 106. For instance, the cover 520 can be removed so that the anvil ring 110 may be removed, serviced, or replaced.

The cover 520 may also include a sealing piece 528 configured to couple the cover 520 with the lid 104 of the VSI 100. The sealing piece 528 can fit between a pair of sealing strips 530 on the lid 104 to maintain the lid 104 in the closed position. The pair of sealing strips 530 can line the perimeter of the lid 104 to couple with the cover 520 and the edge of the VSI housing 102. The latches 304 of the VSI housing 102 can provide additional stabilization in securing the lid 104 in the closed position.

FIG. 5 illustrates the adjustable jack bolt assembly 106 in an upper limit position 532. The upper limit position 532 is defined by the bolt being adjusted as far as possible in the positive direction 523 on the jack bolt axis 525. The upper limit position 532 may be further defined by the tab 402 contacting the sealing piece 528 as shown in FIG. 5.

The door 522 may be removably coupled to the first side 218 of the jack bolt housing 204 via screws, bolts, rivets, clamps or any other coupling mechanism known in the art. The door 522 may include a handle 534 configured to facilitate removal of the door 522. The door 522 may be removed from the jack bolt housing 204 to allow for maintenance or replacement of the components of the adjustable jack bolt assembly 106. For instance, the door 522 can be removed so that dust and debris may be cleared from behind the plurality of anvils 108.

The exterior portion 506 includes the first end 206 of the jack bolt 202, a first locking nut 210, a flat washer 212, a second locking nut 536, and an indicator plate 538. As described above, the first locking nut 210 may be fixedly coupled to the first end 206 of the jack bolt 202. The first locking nut 210 may be configured to be a means by which a user adjustably moves the jack bolt 202 along the jack bolt axis 525. For instance, a user may use a separate tool (not shown) such as a wrench to grip the first locking nut 210 and rotate the jack bolt 202. Because the jack bolt 202 is threaded, it may adjustably move in the positive or negative direction along the jack bolt axis 525 depending on which way the user the rotates the jack bolt 202. For instance, a user may rotate the jack bolt 202 in a counterclockwise direction so that the jack bolt 202 moves in the positive direction 523. In another embodiment, rotating the jack bolt 202 in a clockwise direction may move the jack bolt 202 in the positive direction 523.

The flat washer 212 may be coupled to the jack bolt 202 and the first locking nut 210 via welding, glue, or any other means known in the art. As illustrated in FIG. 1, an indicator plate 538 may be coupled to the VSI housing 102 at a location below the adjustable jack bolt assembly 106. The indicator plate 538 may be marked in increments of length such as inches or centimeters. The flat washer 212 and indicator plate 538 may be configured to show how far a user adjusts the jack bolt 202 along the jack bolt axis 525. A user may track how far the jack bolt 202 is adjusted along the jack bolt axis 525 by monitoring how far the flat washer 212 moves up or down the indicator plate 538.

The second locking nut 536 may be threadably coupled to the jack bolt 202 and fixedly coupled to the bottom 222 of the jack bolt housing 204. The flat washer 212 may become flush with the second locking nut 536 when the jack bolt 202 is in the upper limit position 532 as shown in FIG. 5.

Referring now to FIG. 6, a transverse side view of the present disclosure is illustrated to give a different perspective and bring clarity to the present disclosure. In FIG. 6, the jack bolt 202 is shown in a lower limit position 600. The lower limit position 600 may be defined by the jack bolt 202 being lowered by a user in the method described above in the negative direction 524 until the jack bolt 202 cannot adjust any lower. The tab 402 of the anvil ring 110 may contact the VSI housing 102 at a contact location 602 as illustrated in FIG. 6 to further define the lower limit position 600.

While an exemplary embodiment incorporating the principles of the present application has been disclosed hereinabove, the present application is not limited to the disclosed embodiments. Instead, this application is intended to cover any variations, uses, or adaptations of the application using its general principles. Further, this application is intended to cover such departures from the present disclosure as come within known or customary practice in the art to which this present application pertains and which fall within the limits of the appended claims.

The terminology used herein is for the purpose of describing particular illustrative embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations).

1. An anvil adjustment assembly of a vertical shaft impactor, comprising:
an anvil ring configured to be disposed within a housing of the vertical shaft impactor, the anvil ring comprising at least one tab protruding outwardly;
an elongate jack bolt having a first end and a second end, the bolt including a threaded portion formed between the first and second ends;
a jack bolt housing having a cover and a door, the jack bolt housing configured to be coupled to the housing;
a first locking collar and a second locking collar each coupled to the jack bolt, where the first locking nut is coupled to the jack bolt on one side of the at least one tab, and the second locking nut being coupled to the jack bolt on the opposite side of the at least one tab;
wherein, the jack bolt is movable along a longitudinal axis within the jack bolt housing between a first position and a second position;
further wherein, a movement of the jack bolt along the longitudinal axis induces longitudinal movement of the anvil ring.

2. The assembly of claim 1, further comprising a first locking nut coupled to the first end of the jack bolt and a second locking nut fixedly coupled to the jack bolt housing, wherein rotational movement of the first locking nut induces longitudinal movement of the jack bolt relative to the second locking nut.

3. The assembly of claim 2, wherein the first and second locking collars are coupled to the jack bolt and move longitudinally with the jack bolt.

4. The assembly of claim 1, wherein the jack bolt moves longitudinally between an upper limit and a lower limit, where in the upper limit the at least one tab contacts the jack bolt housing and in the lower limit the at least one tab is configured to contact the housing.

5. The assembly of claim 1, wherein the jack bolt housing includes a top, a bottom, a first side, a second side, a first wall, and a second wall, wherein the second side comprises at least three edges that define an opening through which the at least one tab is received in the jack bolt housing.

6. The assembly of claim 1, wherein the at least one tab comprises a plurality of tabs circumferentially and equidistantly spaced from one another.

7. The assembly of claim 1, wherein the at least one tab defines an opening through which the jack bolt is inserted.

8. The assembly of claim 1, wherein the anvil ring comprises an inner surface that defines a plurality of slots, where each of the plurality of slots is configured to receive an anvil.

9. A vertical shaft impactor, comprising:
a housing including an outer wall that defines an interior chamber, the outer wall further defining a cutout portion;
a lid coupled to the housing for closing off the interior chamber;
an anvil ring disposed within the interior chamber;
a bolt assembly coupled to the housing, the bolt assembly comprising a bolt housing and a bolt that moves in a longitudinal direction within the bolt housing;
wherein, the bolt housing comprises at least one side having an open face for receiving the anvil ring;
wherein, the bolt is coupled to the anvil ring such that longitudinal movement of the bolt induces longitudinal movement of the anvil ring.

10. The impactor of claim 9, wherein the bolt assembly is coupled to the outer wall at the cutout.

11. The impactor of claim 10, wherein the anvil ring protrudes through the cutout and through an opening defined in the bolt housing.

12. The impactor of claim 9, further comprising an indicator plate coupled to the housing at a location below the bolt assembly, the indicator plate including a plurality of markings indicative of length dimensions.

13. The impactor of claim 9, further comprising:
at least one tab of the anvil ring protruding outwardly and configured to be coupled to the bolt; and
a first locking collar and a second locking collar each coupled to the bolt, where the first locking nut is coupled to the bolt on one side of the at least one tab, and the second locking nut is coupled to the bolt on the opposite side of the at least one tab.

14. The impactor of claim 13, wherein the first and second locking collars move longitudinally with the bolt.

15. The impactor of claim 13, wherein the bolt moves longitudinally between an upper limit and a lower limit, where in the upper limit the at least one tab contacts the bolt housing and in the lower limit the at least one tab is configured to contact the housing.

16. A vertical shaft impact crushing apparatus, comprising:
a housing;
a chamber defined within the housing, the chamber having a central region and an outer periphery;
a lid for closing the chamber, wherein the lid defines a plurality of openings positioned about the perimeter of the lid;
an anvil ring configured to be disposed within a housing of the vertical shaft impactor, the anvil ring comprising at least one tab extending radially outwardly;
an elongate jack bolt having a first end and a second end, the bolt including a threaded portion formed between the first and second ends;
a jack bolt housing having a cover and a door, the jack bolt housing configured to be coupled to the housing; and
a first locking collar and a second locking collar each coupled to the jack bolt, where the first locking nut is coupled to the jack bolt on one side of the at least one tab, and the second locking nut being coupled to the jack bolt on the opposite side of the at least one tab;
wherein, the jack bolt is movable along a longitudinal axis within the jack bolt housing between a first position and a second position;
further wherein, a movement of the jack bolt along the longitudinal axis induces longitudinal movement of the anvil ring.

17. The vertical shaft impact crushing apparatus of claim 16, further comprising a first locking nut coupled to the first end of the jack bolt and a second locking nut fixedly coupled to the jack bolt housing, wherein rotational movement of the first locking nut induces longitudinal movement of the jack bolt relative to the second locking nut and the jack bolt housing.

18. The vertical shaft impact crushing apparatus of claim 16, wherein the first and second locking collars are coupled to the jack bolt such that both collars move longitudinally with the jack bolt but do not move relative to one another.

19. The vertical shaft impact crushing apparatus of claim 16, wherein the jack bolt moves longitudinally between an upper limit and a lower limit, where at the upper limit the at least one tab contacts the jack bolt housing and at the lower limit the at least one tab is configured to contact the housing.

20. The vertical shaft impact crushing apparatus of claim 16, wherein:
the housing includes an outer wall with a defined cutout;
the jack bolt housing coupled to the housing at the location of the defined cutout, the jack bolt housing including a top, a bottom, a first side, a second side, a first wall, and a second wall; and
the second side comprises at least three edges that define an opening such that the at least one tab extends through the defined cutout and opening and is received in the jack bolt housing.
